(19) United States
(12) Patent Application Publication
(10) Pub. No.: US 2023/0339510 A1
(43) Pub. Date: Oct. 26, 2023

(54) MANAGEMENT SYSTEM FOR AUTONOMOUS TRAVEL VEHICLE AND MANAGEMENT METHOD FOR AUTONOMOUS TRAVEL VEHICLE

(71) Applicants: Komatsu Ltd., Tokyo (JP); Toyota Jidosha Kabushiki Kaisha, Toyota-shi (JP)

(72) Inventors: Takashi Hiranaka, Tokyo (JP); Shota Konishi, Tokyo (JP); Takahiro Okano, Chiryu-shi (JP); Toru Takashima, Susono-shi (JP); Shun Mizoo, Zama-shi (JP); Shun Maruyama, Numazu-shi (JP)

(73) Assignees: Komatsu Ltd., Tokyo (JP); Toyota Jidosha Kabushiki Kaisha, Toyota-shi (JP)

(21) Appl. No.: 18/302,967

(22) Filed: Apr. 19, 2023

(30) Foreign Application Priority Data
Apr. 22, 2022 (JP) 2022-070693

(51) Int. Cl. B60W 60/00; E02F 9/26

(52) U.S. Cl. CPC B60W 60/00253; E02F 9/26; B60W 2556/45; G06Q 50/30

(57) ABSTRACT

A management system for an autonomous travel vehicle includes: a work machine position acquisition unit that acquires a position of a work machine operated by an operator and having a travel device; and a target position determination unit that determines a target position of the autonomous travel vehicle based on the position of the work machine.

### CROSS-REFERENCE TO RELATED APPLICATION(S)

The present application claims priority to and incorporates by reference the entire contents of Japanese Patent Application No. 2022-070693 filed in Japan on Apr. 22, 2022.

### BACKGROUND OF THE INVENTION

### 1. Field of the Invention

The present disclosure relates to a management system for an autonomous travel vehicle and a management method for an autonomous travel vehicle.

### 2. Description of the Related Art

In a technical field related to a management system of an autonomous travel vehicle, a management system as disclosed in JP 2019-116890 A is known.

At a work site, a work machine operated by an operator is in operation. The operator needs to go back and forth between the work machine and the office at the break time or the timing of the work shift. There is a demand for a technique that allows the operator to come and go smoothly.

An object of the present disclosure is to smoothly perform traffic of operators at a work site.

### SUMMARY OF THE INVENTION

It is an object of the present invention to at least partially solve the problems in the conventional technology.

According to an aspect of the present invention, a management system for an autonomous travel vehicle, comprises: a work machine position acquisition unit that acquires a position of a work machine operated by an operator and having a travel device; and a target position determination unit that determines a target position of the autonomous travel vehicle based on the position of the work machine.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating a work site according to a first embodiment;

FIG. 2 is a schematic diagram illustrating a management system of the work site according to the first embodiment;

FIG. 3 is a block diagram illustrating the management system of the work site according to the first embodiment;

FIG. 4 is a hardware configuration diagram of a management device according to the first embodiment;

FIG. 5 is a schematic diagram for explaining travel data of an unmanned light vehicle according to the first embodiment;

FIG. 6 is a flowchart illustrating a method of managing the unmanned light vehicle according to the first embodiment;

FIG. 7 is a schematic diagram illustrating a method of managing an unmanned light vehicle according to the first embodiment;

FIG. 8 is a flowchart illustrating a method of managing an unmanned light vehicle according to a second embodiment;

FIG. 9 is a schematic diagram illustrating the method of managing the unmanned light vehicle according to the second embodiment;

FIG. 10 is a schematic diagram illustrating a method of managing an unmanned light vehicle according to a third embodiment;

FIG. 11 is a schematic diagram illustrating a method of managing an unmanned light vehicle according to a fourth embodiment; and

FIG. 12 is a flowchart illustrating the method of managing the unmanned light vehicle according to the fourth embodiment.

### DETAILED DESCRIPTION OF THE PREFERRED EMBODIMENTS

Hereinafter, embodiments according to the present disclosure will be described with reference to the drawings, but the present disclosure is not limited to the embodiments. The components of the embodiments described below can be appropriately combined. Furthermore, some components may not be used.

### First Embodiment

A first embodiment will be described.

Work Site

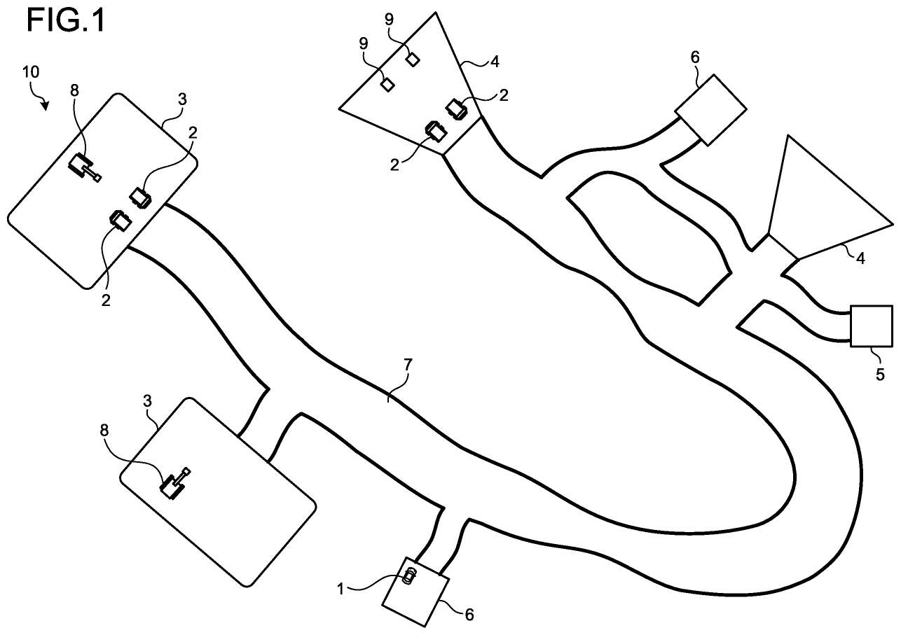

FIG. 1 is a schematic diagram illustrating a work site 10 according to the present embodiment. As the work site 10, a wide-area work site such as a mine or a quarry is exemplified. The mine refers to a place or a place of business where minerals are mined. A quarry refers to a place or business site where stones are mined. Examples of the mine include a metal mine for mining metal, a non-metal mine for mining limestone, and a coal mine for mining coal.

In the work site 10, an autonomous travel vehicle 1, a work machine 2, and a work machine 8 operate. The autonomous travel vehicle refers to a vehicle that travels without a driver's driving operation.

In the present embodiment, the autonomous travel vehicle 1 is a lightweight vehicle that travels through the work site 10 without a driver. In the present embodiment, the autonomous travel vehicle 1 is appropriately referred to as an unmanned light vehicle 1.

In the present embodiment, the unmanned light vehicle 1 transports a person at the work site 10. That is, although a driver does not board the unmanned light vehicle 1, a passenger who does not perform the driving operation boards the unmanned light vehicle 1.

In the present embodiment, the work machine 2 is an unmanned vehicle that operates in an unmanned manner without depending on a driving operation by a driver. In a case where the work machine 2 travels at the work site 10, the driver does not board the work machine 2. Note that the driver may board the work machine 2 in maintenance of the work machine 2 and other predetermined work. In the present embodiment, the work machine 2 is a haul vehicle that performs a transport operation of transporting a load. The haul vehicle travels at the work site 10 in an unmanned manner. In the present embodiment, the work machine 2 is appropriately referred to as an unmanned dump truck 2.

In the present embodiment, the work machine 8 is a manned vehicle operated by an operation by an operator. The operator boards the work machine 8. In the present embodiment, the work machine 8 is a loader that performs loading work of loading a cargo onto the unmanned dump truck 2. In the present embodiment, the work machine 8 is appropriately referred to as an excavator 8.

The work site 10 includes a loading yard 3, a soil discharging yard 4, a parking yard 5, a waiting yard 6, and a travel path 7.

The loading yard 3 is an area in which loading work for loading a cargo onto the unmanned dump truck 2 is performed. As the cargo, an excavated object excavated in the loading yard 3 is exemplified. The excavator 8 operates in the loading yard 3. The excavator 8 includes a travel device, a revolving body supported by the travel device, and working equipment supported by the revolving body. The excavator 8 can move at the work site 10 including the loading yard 3.

The soil discharging yard 4 is an area in which soil discharging work for discharging a cargo from the unmanned dump truck 2 is performed. A crusher 9 is provided in the soil discharging yard 4.

The parking yard 5 is an area where the unmanned dump truck 2 is parked.

The waiting yard 6 is an area where the unmanned light vehicle 1 waits.

The travel path 7 refers to an area where at least one of the unmanned light vehicle 1 and the unmanned dump truck 2 travels. The travel path 7 is provided so as to connect at least the loading yard 3 and the soil discharging yard 4. In the present embodiment, the travel path 7 is connected to each of the loading yard 3, the soil discharging yard 4, the parking yard 5, and the waiting yard 6.

The unmanned light vehicle 1 can travel in each of the loading yard 3, the soil discharging yard 4, the waiting yard 6, and the travel path 7. The unmanned dump truck 2 can travel in each of the loading yard 3, the soil discharging yard 4, the parking yard 5, and the travel path 7. For example, the unmanned dump truck 2 travels on the travel path 7 so as to reciprocate between the loading yard 3 and the soil discharging yard 4.

Management System

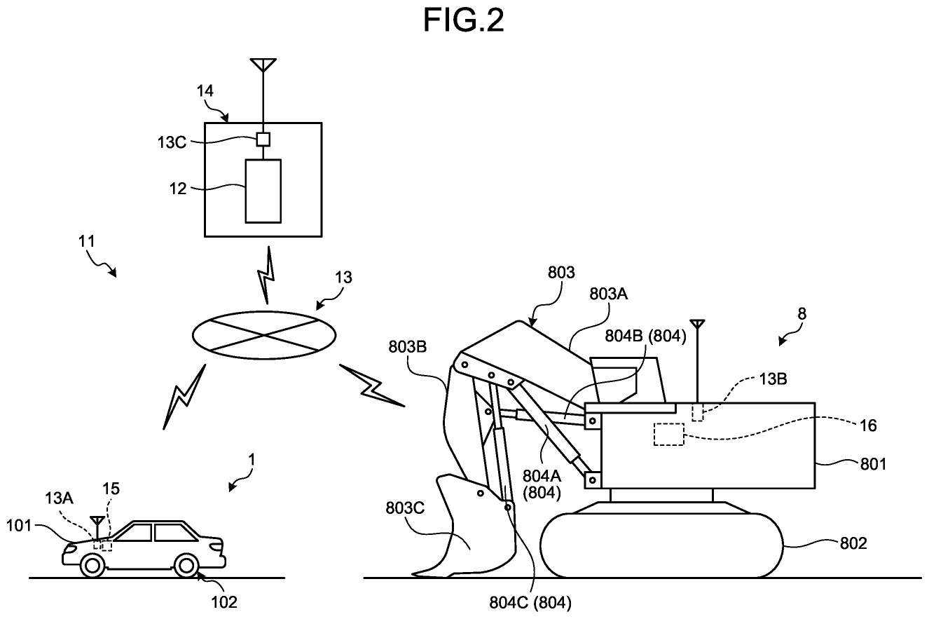

FIG. 2 is a schematic diagram illustrating a management system 11 of the work site 10 according to the present embodiment. The management system 11 includes a management device 12 and a communication system 13.

The management device 12 includes a computer system. The management device 12 is disposed outside the unmanned light vehicle 1, the unmanned dump truck 2, and the excavator 8. The management device 12 is installed in a control facility 14 of the work site 10. The management device 12 manages the work site 10. The management device 12 manages at least the unmanned light vehicle 1, the unmanned dump truck 2, and the excavator 8.

Examples of the communication system 13 include the Internet, a mobile phone communication network, a satellite communication network, and a local area network (LAN).

The unmanned light vehicle 1 includes a vehicle body 101, a travel device 102, a control device 15, and a wireless communication device 13A. The control device 15 includes a computer system. The wireless communication device 13A is connected to the control device 15.

The excavator 8 is operated by an operator. The excavator 8 includes a revolving body 801, a travel device 802 that supports the revolving body 801, working equipment 803 supported by the revolving body 801, a working equipment cylinder 804 that operates the working equipment 803, a control device 16, and a wireless communication device 13B. The control device 16 includes a computer system. The wireless communication device 13B is connected to the control device 16.

The communication system 13 includes the wireless communication device 13A connected to the control device 15, the wireless communication device 13B connected to the control device 16, and a wireless communication device 13C connected to the management device 12. The management device 12 and the control device 15 of the unmanned light vehicle 1 perform wireless communication via the communication system 13. The management device 12 and the control device 16 of the excavator 8 perform wireless communication via the communication system 13.

The vehicle body 101 includes a vehicle body frame. The vehicle body 101 is supported by the travel device 102. The travel device 102 travels while supporting the vehicle body 101. The travel device 102 includes a wheel, a tire mounted on the wheel, an engine, a brake device, and a steering device.

The revolving body 801 revolves while being supported by the travel device 802. The travel device 802 includes a pair of crawler belts. The travel device 802 allows the excavator 8 to move at the work site 10 including the loading yard 3. The working equipment 803 includes a boom 803A rotatably coupled to the revolving body 801, an arm 803B rotatably coupled to the boom 803A, and a bucket 803C rotatably coupled to the arm 803B. The working equipment cylinder 804 is a hydraulic cylinder. The working equipment cylinder 804 includes a boom cylinder 804A that raises or lowers the boom 803A, an arm cylinder 804B that tilts or dumps the arm 803B, and a bucket cylinder 804C that tilts or dumps the bucket 803C.

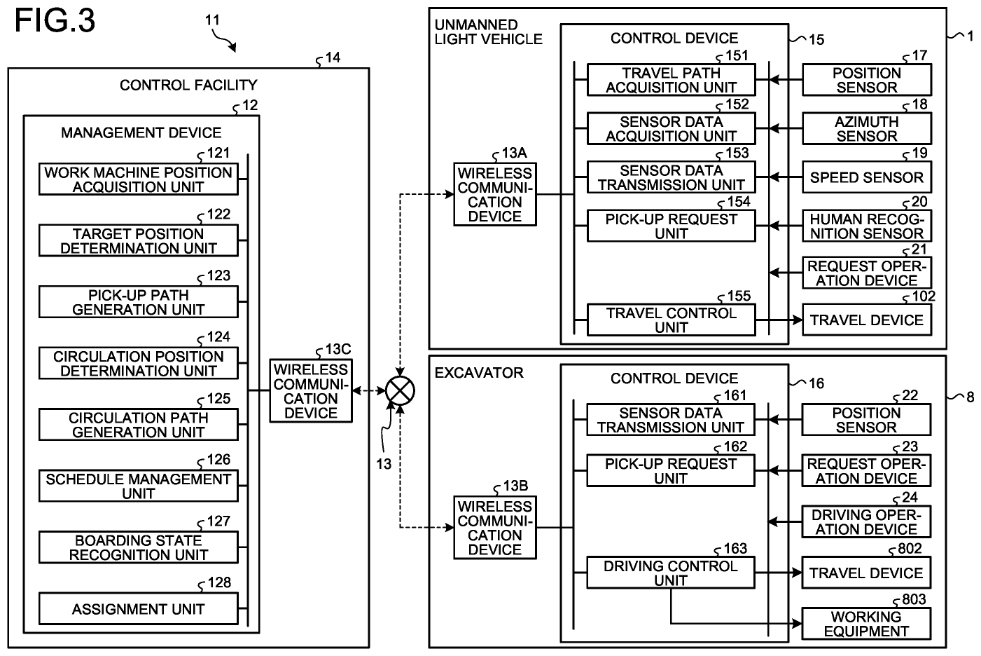

FIG. 3 is a block diagram illustrating the management system 11 of the work site 10 according to the present embodiment.

The unmanned light vehicle 1 includes the control device 15, the wireless communication device 13A, a position sensor 17, an azimuth sensor 18, a speed sensor 19, a human recognition sensor 20, a request operation device 21, and the travel device 102. Each of the wireless communication device 13A, the position sensor 17, the azimuth sensor 18, the speed sensor 19, the human recognition sensor 20, and the request operation device 21 can communicate with the control device 15. The travel device 102 is controlled by the control device 15.

The position sensor 17 detects a position of the unmanned light vehicle 1. The position of the unmanned light vehicle 1 is detected using a global navigation satellite system (GNSS). The global navigation satellite system includes a global positioning system (GPS). The global navigation satellite system detects a position in a global coordinate system defined by coordinate data of latitude, longitude, and altitude. The global coordinate system refers to a coordinate system fixed to the earth. The position sensor 17 includes a GNSS receiver and detects an absolute position of the unmanned light vehicle 1 indicating a position of the unmanned light vehicle 1 in the global coordinate system.

The azimuth sensor 18 detects an azimuth of the unmanned light vehicle 1. The azimuth of the unmanned light vehicle 1 includes a yaw angle of the unmanned light vehicle 1. In a case where an axis extending in a vertical direction at a center of gravity of the vehicle body 101 is a yaw axis, the yaw angle refers to a rotation angle around the yaw axis. A gyro sensor is exemplified as the azimuth sensor 18.

The speed sensor 19 detects a travel speed of the unmanned light vehicle 1. As the speed sensor 19, a pulse sensor that detects rotation of a wheel of the unmanned light vehicle 1 is exemplified.

The human recognition sensor 20 recognizes whether or not a person is present inside the unmanned light vehicle 1. That is, the human recognition sensor 20 detects the presence or absence of a passenger in the unmanned light vehicle 1. A seat on which a passenger sits is disposed inside the unmanned light vehicle 1. As the human recognition sensor 20, a pressure-sensitive sensor provided on the sheet is exemplified. Note that the human recognition sensor 20 may be a weight sensor that detects a weight of the passenger or an in-vehicle camera that acquires an image of the passenger.

The request operation device 21 is operated by an operator when the operator requests pick-up. As the request operation device 21, a push button or a touch panel disposed inside the unmanned light vehicle 1 is exemplified.

The excavator 8 includes the control device 16, the wireless communication device 13B, a position sensor 22, a request operation device 23, a driving operation device 24, the travel device 802, and the working equipment 803. Each of the wireless communication device 13B, the position sensor 22, the request operation device 23, and the driving operation device 24 can communicate with the control device 16.

The position sensor 22 detects a position of the excavator 8. The position sensor 22 includes a GNSS receiver and detects an absolute position of the excavator 8 indicating a position of the excavator 8 in the global coordinate system.

The request operation device 23 is operated by an operator when the operator requests pick-up. As the request operation device 23, a push button or a touch panel disposed inside the excavator 8 is exemplified.

The driving operation device 24 is operated by an operator when the travel device 802 and the working equipment 803 are operated. The driving operation device 24 includes a travel lever operated to operate the travel device 802 and a work lever operated to operate the working equipment 803.

The management device 12 includes a work machine position acquisition unit 121, a target position determination unit 122, a pick-up path generation unit 123, a circulation position determination unit 124, a circulation path generation unit 125, a schedule management unit 126, a boarding state recognition unit 127, and an assignment unit 128.

The work machine position acquisition unit 121 acquires a position of the excavator 8. As described above, the excavator 8 includes the position sensor 22 that detects the position of the excavator 8. The work machine position acquisition unit 121 acquires the position of the excavator 8 by acquiring detection data of the position sensor 22 via the communication system 13.

The target position determination unit 122 determines a target position of the unmanned light vehicle 1 based on the position of the excavator 8 acquired by the work machine position acquisition unit 121. In the present embodiment, the target position is a getting-on/off position of the operator.

The pick-up path generation unit 123 generates travel data indicating a travel condition of the unmanned light vehicle 1. The pick-up path generation unit 123 generates travel data of the unmanned light vehicle 1 when the operator is picked up by the unmanned light vehicle 1 based on the target position determined by the target position determination unit 122. The pick-up path generation unit 123 transmits the travel data to the unmanned light vehicle 1 via the communication system 13.

The circulation position determination unit 124 determines a circulation position when the unmanned light vehicle 1 is circulated at the work site 10. A plurality of the circulation positions is set. At least one of the circulation positions is a getting-on/off position of the operator. The circulation position determination unit 124 determines, as a circulation position, the operator's getting-on/off position determined by the target position determination unit 122. Furthermore, an arbitrary fixed position set in the work site 10 is included. In the present embodiment, the arbitrary fixed position set in the work site 10 is a position of a gas station of the excavator 8 or the unmanned dump truck 2. The gas station is provided, for example, in the parking yard 5.

The circulation path generation unit 125 generates travel data indicating a travel condition of the unmanned light vehicle 1. The circulation path generation unit 125 generates travel data of the unmanned light vehicle 1 when the unmanned light vehicle 1 is circulated at the work site 10 based on the plurality of circulation positions determined by the circulation position determination unit 124. The circulation path generation unit 125 transmits the travel data to the unmanned light vehicle 1 via the communication system 13.

The schedule management unit 126 manages a departure time or a return time of the unmanned light vehicle 1.

The boarding state recognition unit 127 recognizes a boarding state of a person in the unmanned light vehicle 1. The boarding state of a person in the unmanned light vehicle 1 includes the presence or absence of a person inside the unmanned light vehicle 1 and the number of persons in a case where the persons are present. As described above, the unmanned light vehicle 1 includes the human recognition sensor 20 that recognizes whether or not a person is present inside the unmanned light vehicle 1. The boarding state recognition unit 127 can recognize the boarding state of the person in the unmanned light vehicle 1 by acquiring detection data of the human recognition sensor 20 via the communication system 13. In the present embodiment, the boarding state recognition unit 127 can determine whether or not the unmanned light vehicle 1 is in a full state based on the detection data of the human recognition sensor 20.

The assignment unit 128 assigns a predetermined operation to a plurality of the unmanned light vehicles 1. There are the plurality of unmanned light vehicles 1 at the work site 10. The assignment unit 128 can assign a certain unmanned light vehicle 1 among the plurality of unmanned light vehicles 1 to pick-up of an operator or assign a certain unmanned light vehicle 1 to circulation at the work site 10. The unmanned light vehicle 1 assigned to the pick-up of the operator may be a passenger car type vehicle. The unmanned light vehicle 1 assigned to the circulation at the work site 10 may be a microbus type vehicle. Furthermore, the assignment unit 128 can output an operation command including at least one of an operation start, an operation continuation, an operation interruption, and an operation end of the unmanned light vehicle 1.

The control device 15 includes a travel path acquisition unit 151, a sensor data acquisition unit 152, a sensor data transmission unit 153, a pick-up request unit 154, and a travel control unit 155.

The travel path acquisition unit 151 acquires the travel data of the unmanned light vehicle 1 generated by at least one of the pick-up path generation unit 123 and the circulation path generation unit 125 from the management device 12 via the communication system 13.

The sensor data acquisition unit 152 acquires detection data of the position sensor 17, detection data of the azimuth sensor 18, and detection data of the speed sensor 19.

The sensor data transmission unit 153 transmits the detection data of the position sensor 17 and detection data of the human recognition sensor 20 to the management device 12 through the communication system 13.

The pick-up request unit 154 transmits a pick-up request of the operator for the excavator 8 to the management device 12. The pick-up request unit 154 transmits operation data generated by operating the request operation device 21 to the management device 12 via the communication system 13, thereby transmitting the pick-up request to the management device 12.

The travel control unit 155 controls the travel device 102 based on the travel data of the unmanned light vehicle 1 acquired by the travel path acquisition unit 151 and the detection data acquired by the sensor data acquisition unit 152.

The control device 16 includes a sensor data transmission unit 161, a pick-up request unit 162, and a driving control unit 163.

The sensor data transmission unit 161 transmits detection data of the position sensor 22 to the management device 12 via the communication system 13.

The pick-up request unit 162 transmits a pick-up request of the operator for the excavator 8 to the management device 12. The pick-up request unit 162 transmits operation data generated by operating the request operation device 23 to the management device 12 via the communication system 13, thereby transmitting the pick-up request to the management device 12.

The driving control unit 163 controls the travel device 802 and the working equipment 803 on the basis of operation data generated by operating the driving operation device 24.

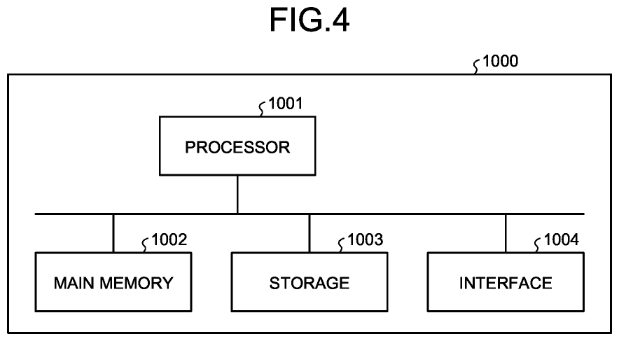

FIG. 4 is a hardware configuration diagram of the management device 12 according to the present embodiment. The management device 12 includes a computer system 1000. The computer system 1000 includes a processor 1001 such as a central processing unit (CPU), a main memory 1002 including a nonvolatile memory such as a read only memory (ROM) and a volatile memory such as a random access memory (RAM), a storage 1003, and an interface 1004 including an input/output circuit. The functions of the management device 12 described above are stored in the storage 1003 as a computer program. The processor 1001 reads the computer program from the storage 1003, develops the computer program in the main memory 1002, and executes the above-described processing according to the program. Note that the computer program may be distributed to the computer system 1000 via a network.

Each of the control device 15 and the control device 16 includes a computer system 1000 as illustrated in FIG. 4. The functions of the control device 15 and the control device 16 described above are stored in the storage 1003 as a computer program.

Travel Data

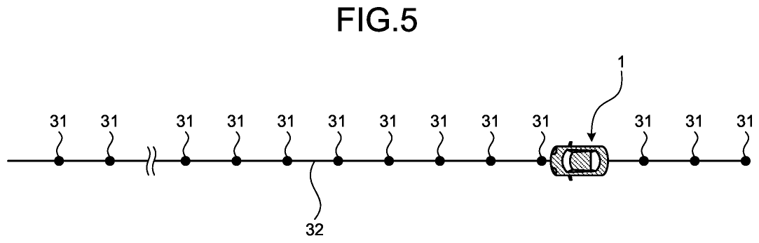

FIG. 5 is a schematic diagram for explaining travel data of the unmanned light vehicle 1 according to the present embodiment.

The travel data of the unmanned light vehicle 1 defines travel conditions of the unmanned light vehicle 1. The travel data of the unmanned light vehicle 1 includes a travel point 31, a travel path 32, a target position of the unmanned light vehicle 1, a target azimuth of the unmanned light vehicle 1, and a target travel speed of the unmanned light vehicle 1. The travel data of the unmanned light vehicle 1 including the travel path 32 is generated by at least one of the pick-up path generation unit 123 and the circulation path generation unit 125.

A plurality of the travel points 31 are set at the work site 10. Each of the travel points 31 defines a target position of the unmanned light vehicle 1. The target azimuth of the unmanned light vehicle 1 and the target travel speed of the unmanned light vehicle 1 are set at each of the plurality of travel points 31. The plurality of travel points 31 are set at intervals. The intervals between the travel points 31 may be uniform or non-uniform.

The travel path 32 refers to a virtual line indicating a target travel route of the unmanned light vehicle 1. The travel path 32 is defined by a trajectory passing through the plurality of travel points 31. The unmanned light vehicle 1 travels through the work site 10 according to the travel path 32. The unmanned light vehicle 1 travels such that a center of the unmanned light vehicle 1 coincides with the travel path 32 in a vehicle width direction of the unmanned light vehicle 1.

The target position of the unmanned light vehicle 1 refers to a target position of the unmanned light vehicle 1 when passing through each of the travel points 31. The target position of the unmanned light vehicle 1 may be defined in the local coordinate system of the unmanned light vehicle 1 or may be defined in the global coordinate system.

The target azimuth of the unmanned light vehicle 1 refers to a target azimuth of the unmanned light vehicle 1 when passing through the travel point 31.

The target travel speed of the unmanned light vehicle 1 refers to a target travel speed of the unmanned light vehicle 1 when passing through the travel point 31.

The pick-up path generation unit 123 generates the travel path 32 of the unmanned light vehicle 1 when the operator is picked up by the unmanned light vehicle 1 based on the target position determined by the target position determination unit 122.

The circulation path generation unit 125 generates the travel path 32 of the unmanned light vehicle 1 when causing the unmanned light vehicle 1 to be circulated at the work site 10 based on the plurality of circulation positions determined by the circulation position determination unit 124.

The travel control unit 155 controls the travel device 102 so that the unmanned light vehicle 1 travels along the travel path 32 based on the travel data of the unmanned light vehicle 1 and the detection data acquired by the sensor data acquisition unit 152.

The travel control unit 155 controls the travel device 102 so as to reduce a deviation between a detection position of the unmanned light vehicle 1 detected by the position sensor 17 when passing through the travel point 31 and the target position of the unmanned light vehicle 1 set at the travel point 31.

The travel control unit 155 controls the travel device 102 so as to reduce a deviation between a detected azimuth of the unmanned light vehicle 1 detected by the azimuth sensor 18 when passing through the travel point 31 and the target azimuth of the unmanned light vehicle 1 set at the travel point 31.

The travel control unit 155 controls the travel device 102 so as to reduce a deviation between a detected travel speed of the unmanned light vehicle 1 detected by the speed sensor 19 when passing through the travel point 31 and the target travel speed of the unmanned light vehicle 1 set at the travel point 31.

Management Method

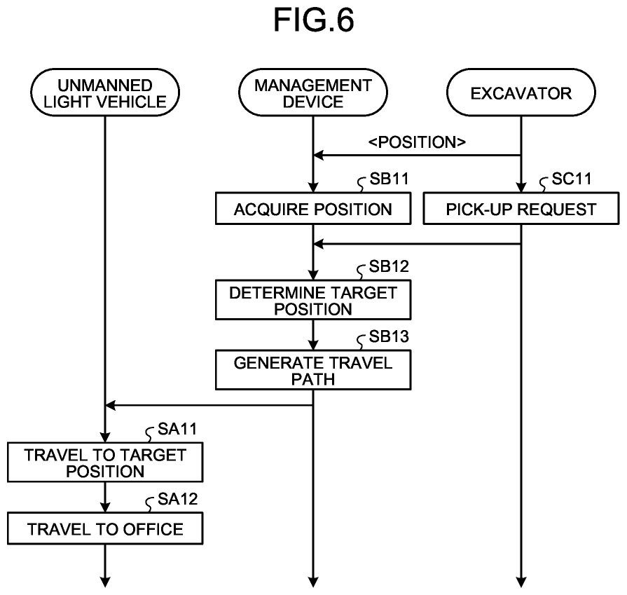

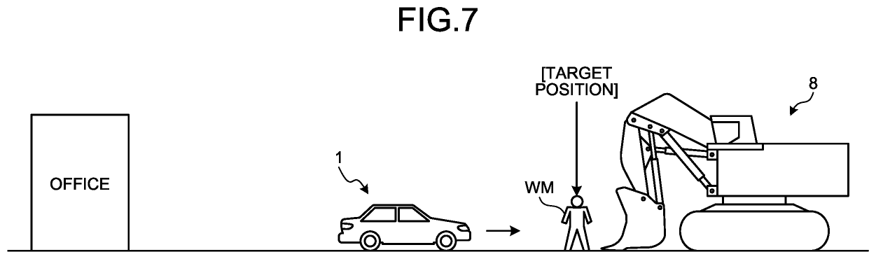

FIG. 6 is a flowchart illustrating a method of managing the unmanned light vehicle 1 according to the present embodiment. FIG. 7 is a schematic diagram illustrating the method of managing the unmanned light vehicle 1 according to the present embodiment.

There is an office (shop) in the waiting yard 6. The office includes a standby facility and a rest facility of the operator. In the present embodiment, the unmanned light vehicle 1 when the unmanned light vehicle 1 is assigned to transportation of an operator from the excavator 8 to the office will be described.

For example, when taking a break or when working hours end, the operator of the excavator 8 operates the request operation device 23 disposed in the excavator 8 to move from the excavator 8 to the office (Step SC11).

The pick-up request unit 162 transmits a pick-up request to the management device 12 via the communication system 13 on the basis of the operation data generated by operating the request operation device 23.

The sensor data transmission unit 161 constantly or periodically transmits the detection data of the position sensor 22 indicating the position of the excavator 8 to the management device 12. The work machine position acquisition unit 121 constantly or periodically acquires the position of the excavator 8 (Step SB11).

In the present embodiment, the position sensor 22 and the sensor data transmission unit 161 function as a position transmission unit that transmits the position of the excavator 8 to the management device 12.

The target position determination unit 122 receives the pick-up request transmitted from the pick-up request unit 162, and specifies the excavator 8 that has transmitted the pick-up request. The target position determination unit 122 determines the target position of the unmanned light vehicle 1 based on the position of the excavator 8 that has transmitted the pick-up request (Step SB12).

As illustrated in FIG. 7, the target position is set in the vicinity of the excavator 8 that has transmitted the pick-up request. The target position is a getting-on/off position of the operator WM.

The pick-up path generation unit 123 generates the travel path 32 of the unmanned light vehicle 1 when the operator is picked up by the unmanned light vehicle 1 based on the target position determined by the target position determination unit 122 in Step SB12 (Step SB13).

In a case where the unmanned light vehicle 1 exists in the office of the waiting yard 6, the pick-up path generation unit 123 generates the travel path 32 so as to connect the office and the target position. The pick-up path generation unit 123 transmits travel data including the travel path 32 to the unmanned light vehicle 1 assigned by the assignment unit 128.

After receiving the travel data including the travel path 32, the unmanned light vehicle 1 travels to the target position based on the travel data (Step SA11).

After the unmanned light vehicle 1 arrives at the target position, the operator WM boards the unmanned light vehicle 1. After the operator WM boards the unmanned light vehicle 1, the unmanned light vehicle 1 travels to the office based on the travel data including the travel path 32 (Step SA12).

As a result, the operator WM can take a break at the office or come home from the office.

### Advantageous Effects

As described above, according to the present embodiment, the operator can smoothly move between the excavator 8 and the office by the unmanned light vehicle 1. The target position of the unmanned light vehicle 1 is determined based on the position of the excavator 8. As a result, the unmanned light vehicle 1 can smoothly pick up and drop off the operator of the excavator 8.

### Second Embodiment

A second embodiment will be described. In the following description, the same or equivalent components as those of the above-described embodiment are denoted by the same reference signs, and the description of the components is simplified or omitted.

Management Method

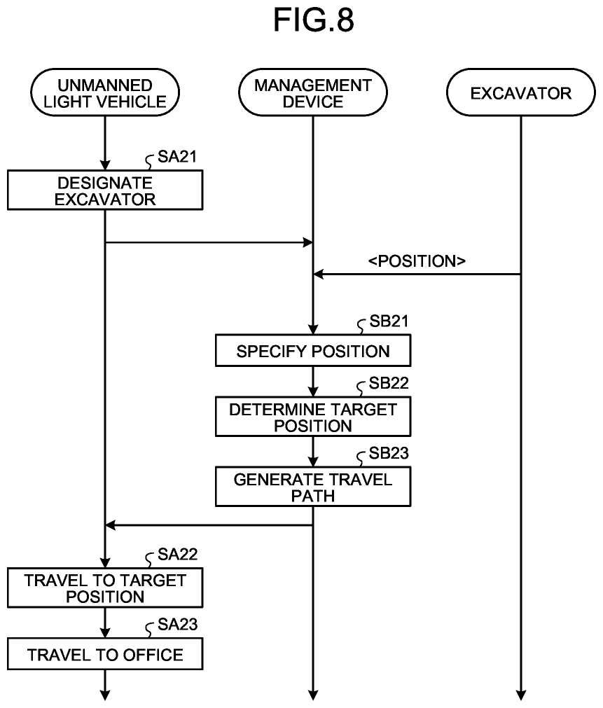

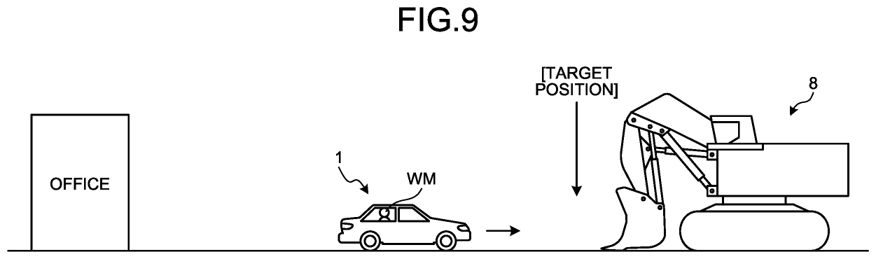

FIG. 8 is a flowchart illustrating a method of managing an unmanned light vehicle 1 according to the present embodiment. FIG. 9 is a schematic diagram illustrating a method of managing the unmanned light vehicle 1 according to the present embodiment.

In the present embodiment, the unmanned light vehicle 1 when the unmanned light vehicle 1 is assigned to transportation of an operator from an office to an excavator 8 will be described.

For example, in a case where a break ends or a working time starts, the operator of the excavator 8 operates a request operation device 21 disposed in the unmanned light vehicle 1 after boarding the unmanned light vehicle 1 in a waiting yard 6 in order to move from the office to the excavator 8.

The operator operates the request operation device 21 to input a target position of the unmanned light vehicle 1. The target position is a getting-on/off position of the excavator 8 on which the operator should board. The target position is a getting-on/off position of the excavator 8 that the operator wants to board among a plurality of the excavators 8 present at a work site 10. The target position is a getting-on/off position of the excavator 8 to which the operator is to be sent among the plurality of excavators 8 existing in the work site 10.

In the present embodiment, the request operation device 21 is disposed in the unmanned light vehicle 1 and functions as a work machine designation unit that designates the excavator 8 which is the target position of the operator. A pick-up request unit 154 functions as a transfer request unit that transmits a transfer request for sending the operator to the excavator 8 which is the target position. In the present embodiment, transmitting the transfer request for sending the operator to the target position includes transmitting the excavator 8 designated at the target position.

The operator of the excavator 8 operates the request operation device 21 disposed in the unmanned light vehicle 1 to designate an excavator 8 to be boarded among a plurality of the excavators 8 existing at the work site 10 (Step SA21).

The pick-up request unit 154 transmits the excavator 8 designated in Step SA21 to the management device 12. The excavator 8 designated in Step SA21 is an excavator 8 to which the operator is to be sent.

A work machine position acquisition unit 121 always acquires the position of each of the plurality of excavators 8 present at the work site 10. The work machine position acquisition unit 121 specifies the position of the excavator 8 designated in Step SA21 (Step SB21).

A target position determination unit 122 determines the target position of the unmanned light vehicle 1 based on the position of the excavator 8 specified in Step SB21 (Step SB22).

As illustrated in FIG. 9, the target position is set in the vicinity of the excavator 8 desired by the operator. The target position is a getting-on/off position of the operator WM.

A pick-up path generation unit 123 generates a travel path 32 of the unmanned light vehicle 1 when the operator is sent by the unmanned light vehicle 1 based on the target position determined by the target position determination unit 122 in Step SB22 (Step SB23).

In a case where the unmanned light vehicle 1 exists in the office of the waiting yard 6, the pick-up path generation unit 123 generates the travel path 32 so as to connect the office and the target position. The pick-up path generation unit 123 transmits travel data including the travel path 32 to the unmanned light vehicle 1 assigned by the assignment unit 128.

After receiving travel data including the travel path 32, the unmanned light vehicle 1 travels to the target position based on the travel data (Step SA22).

After the unmanned light vehicle 1 arrives at the target position, the operator WM gets off the unmanned light vehicle 1. The operator WM getting off the unmanned light vehicle 1 gets on the excavator 8. After the operator WM gets off the unmanned light vehicle 1, the unmanned light vehicle 1 travels to the office based on the travel data including the travel path 32 (Step SA23).

As a result, the operator WM can board the excavator 8 and start work.

### Advantageous Effects

As described above, also in the present embodiment, the unmanned light vehicle 1 can smoothly pick up and drop off the operator of the excavator 8.

### Third Embodiment

A third embodiment will be described. In the following description, the same or equivalent components as those of the above-described embodiment are denoted by the same reference signs, and the description of the components is simplified or omitted.

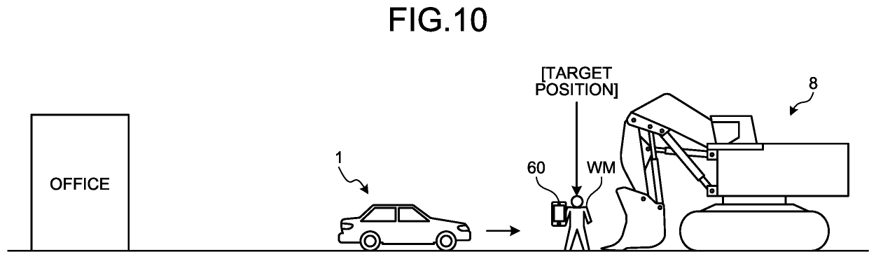

FIG. 10 is a schematic diagram illustrating a method of managing an unmanned light vehicle 1 according to the present embodiment. The third embodiment is a modification example of the first embodiment and the second embodiment described above.

As illustrated in FIG. 10, an operator may have a communication terminal 60 capable of transmitting a position of an excavator 8 to a management device 12. The operator can carry the communication terminal 60. The operator who wants to move from the excavator 8 to an office can operate the communication terminal 60 to transmit the position of the excavator 8 to the management device 12 before or after getting off the excavator 8.

Furthermore, the operator who wants to move from the office to the excavator 8 can operate the communication terminal 60 to transmit the position of the excavator 8 to the management device 12 before or after getting on the unmanned light vehicle 1.

In the present embodiment, the communication terminal 60 functions as a position transmission unit that transmits the position of the excavator 8 to the management device 12.

### Advantageous Effects

As described above, also in the present embodiment, the unmanned light vehicle 1 can smoothly pick up and drop off the operator of the excavator 8.

### Modification Examples of First, Second, and Third Embodiments

In the above-described embodiments, after the operator WM as a replacement member gets on the unmanned light vehicle 1 moving from the office to the excavator 8 and the unmanned light vehicle 1 arrives at the getting-on/off position in the vicinity of the excavator 8, the operator WM as a replacement member may move from the unmanned light vehicle 1 to the excavator 8, and an operator WM working at the excavator 8 may get on the unmanned light vehicle 1 and move to the office.

The unmanned light vehicle 1 may transport supplies. For example, an article used for the excavator 8 may be transported from the office to the excavator 8 by the unmanned light vehicle 1. As the article used for the excavator 8, a maintenance device used for maintenance of the excavator 8 is exemplified. Furthermore, the unmanned light vehicle 1 may transport lubricant or fuel used for the excavator 8 from the office to the excavator 8.

### Fourth Embodiment

A fourth embodiment will be described. In the following description, the same or equivalent components as those of the above-described embodiment are denoted by the same reference signs, and the description of the components is simplified or omitted.

Management Method

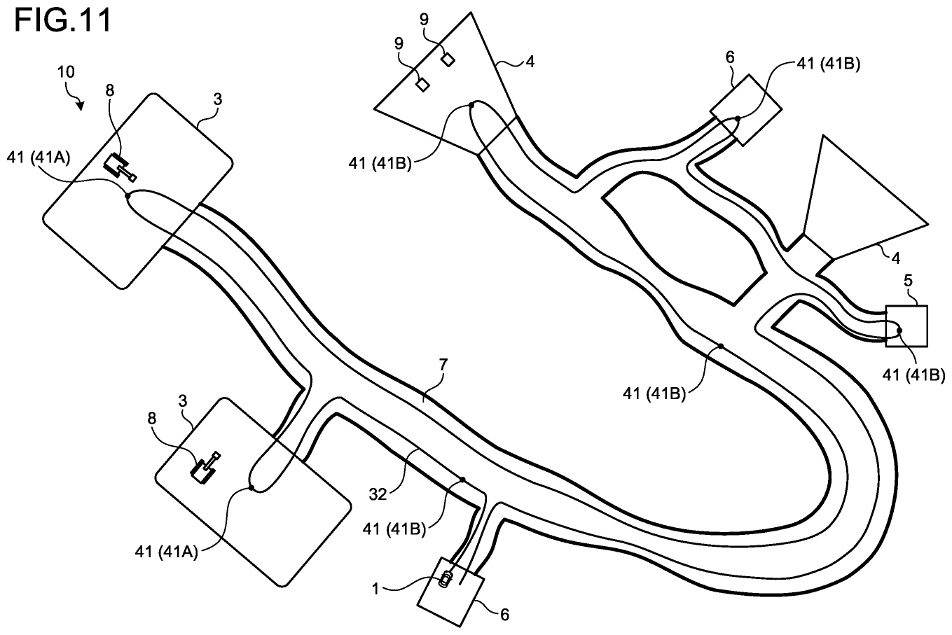

FIG. 11 is a schematic diagram illustrating a method of managing an unmanned light vehicle 1 according to the present embodiment.

As illustrated in FIG. 11, a management device 12 can circulate the unmanned light vehicle 1 at a work site 10. A circulation position determination unit 124 determines a plurality of circulation positions 41. At least one of the plurality of circulation positions 41 is a getting-on/off position 41A of the operator. In the example illustrated in FIG. 11, the getting-on/off position 41A of the operator is set in the vicinity of an excavator 8. A position of the excavator 8 changes according to the situation of excavator 8 loading work or excavation work. The getting-on/off position 41A of the operator is a varying position that changes based on a change in the position of the excavator 8.

Furthermore, the circulation positions 41 include an arbitrary fixed position 41B. As the fixed position 41B, a position of a gas station of the excavator 8 or an unmanned dump truck 2 is exemplified. Note that the fixed position 41B may be set in a travel path 7 or may be set in a soil discharging yard 4.

Based on the plurality of circulation positions 41, a circulation path generation unit 125 generates a travel path 32 when the unmanned light vehicle 1 is circulated at the work site 10. The circulation path generation unit 125 generates the travel path 32 so that the unmanned light vehicle 1 passes through the plurality of circulation positions 41.

The unmanned light vehicle 1 that has left a waiting yard 6 travels along the travel path 32 so as to pass through the plurality of circulation positions 41. The unmanned light vehicle 1 stops at each of the plurality of circulation positions 41. In a case where the unmanned light vehicle 1 stops at the circulation position 41, for example, an operator boarding the unmanned light vehicle 1 can get off the unmanned light vehicle 1 at the circulation position 41. Furthermore, in a case where the unmanned light vehicle 1 stops at the circulation position 41, for example, an operator who has been waiting for the arrival of the unmanned light vehicle 1 at the circulation position 41 can get on the unmanned light vehicle 1 at the circulation position 41. The unmanned light vehicle 1 having passed through a plurality of the circulation positions 41 travels to the waiting yard 6. The waiting yard 6 which is a departure point of the unmanned light vehicle 1 and the waiting yard 6 which is a return point may be the same waiting yard 6 or different waiting yards 6. As described above, the unmanned light vehicle 1 can function as a route bus that travels at the work site 10.

The unmanned light vehicle 1 regularly circulates the work site 10. The unmanned light vehicle 1 circulates the work site every two hours, for example. A schedule management unit 126 manages a departure time from the departure point or a return time to the return point of the unmanned light vehicle 1.

The boarding state recognition unit 127 recognizes a boarding state of a person in the unmanned light vehicle 1. The boarding state recognition unit 127 can determine whether or not the unmanned light vehicle 1 is in a full state based on detection data of a human recognition sensor 20. The full state of the unmanned light vehicle 1 refers to a state in which the number of passengers has reached a predetermined allowable number of people who can board the unmanned light vehicle 1, or a state in which the sum of the weights of the passengers has reached a predetermined allowable weight that can board the unmanned light vehicle 1.

In a case where it is determined that the unmanned light vehicle 1 is in the full state during the circulation at the work site 10, an assignment unit 128 interrupts the circulation of the unmanned light vehicle 1 determined to be in the full state and returns to the waiting yard 6 which is the return point. That is, even if the circulation position 41 exists between an interruption point where the circulation is interrupted and the return point, the unmanned light vehicle 1 determined to be in the full state goes straight to the return point without stopping at the circulation position 41.

In a case where the circulation of the unmanned light vehicle 1 determined to be in the full state is interrupted, the assignment unit 128 causes another unmanned light vehicle 1 to travel to the interruption point. The other unmanned light vehicle 1 travels from the interruption point to the return point while stopping. As a result, the other unmanned light vehicle 1 can get on the operator who has been waiting for the arrival of the unmanned light vehicle 1 at the circulation position 41 between the interruption point and the return point.

Note that in a case where the circulation of the unmanned light vehicle 1 determined to be in the full state is interrupted, the assignment unit 128 may cause the unmanned light vehicle 1 in the full state to travel straight to the waiting yard 6, cause the passenger to get off at the waiting yard 6, and then cause the unmanned light vehicle 1 to travel to the interruption point.

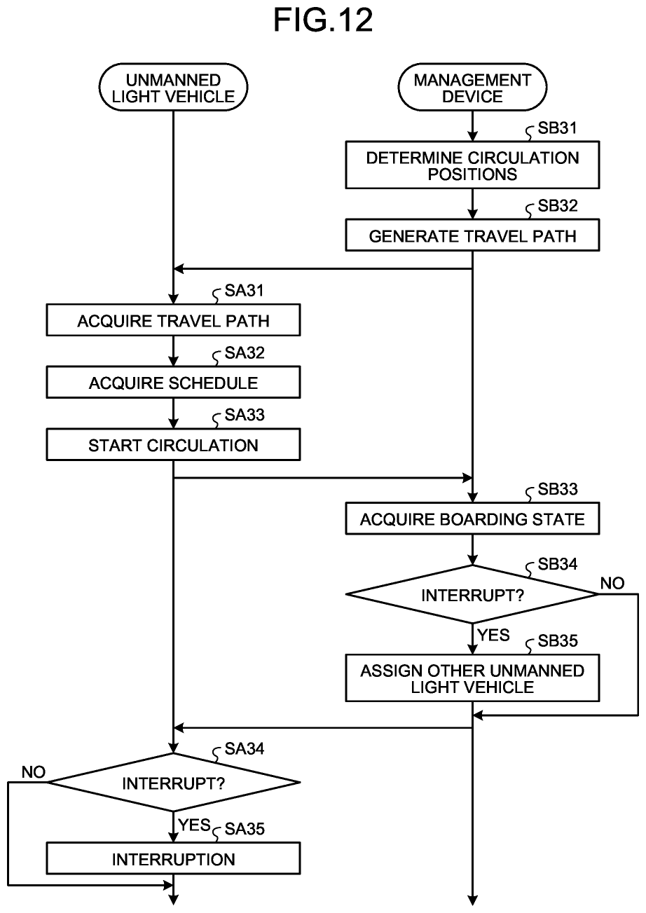

FIG. 12 is a flowchart illustrating a method of managing the unmanned light vehicle 1 according to the present embodiment.

The circulation position determination unit 124 determines the plurality of circulation positions 41 (Step SB31).

The circulation path generation unit 125 generates the travel path 32 so that the unmanned light vehicle 1 passes through the plurality of circulation positions 41 (Step SB32).

The circulation path generation unit 125 transmits the travel path 32 to the unmanned light vehicle 1. A travel path acquisition unit 151 of the unmanned light vehicle 1 acquires the travel path 32 transmitted from the circulation path generation unit 125 (Step SA31).

Furthermore, the travel path acquisition unit 151 acquires a schedule from the schedule management unit 126 (Step SA32).

The schedule transmitted from the schedule management unit 126 includes a departure time or a return time of the unmanned light vehicle 1. When it is the departure time, a travel control unit 155 starts traveling of the unmanned light vehicle 1 based on the travel data including the travel path 32. The unmanned light vehicle 1 starts circulation at the work site 10 (Step SA33).

A sensor data transmission unit 153 constantly or periodically transmits detection data of the human recognition sensor 20 to the management device 12. The boarding state recognition unit 127 acquires the detection data of the human recognition sensor 20 indicating a boarding state of a person in the unmanned light vehicle 1 (Step SB33).

The boarding state recognition unit 127 determines whether or not the unmanned light vehicle 1 is in a full state on the basis of the boarding state of a person in the unmanned light vehicle 1. The assignment unit 128 determines whether or not to interrupt the circulation of the unmanned light vehicle 1 based on the determination as to whether or not the unmanned light vehicle 1 is in the full state (Step SB34).

The assignment unit 128 determines to interrupt the circulation of the unmanned light vehicle 1 in a case where the boarding state recognition unit 127 determines that the unmanned light vehicle 1 is in the full state, and determines not to interrupt the circulation of the unmanned light vehicle 1 in a case where the boarding state recognition unit 127 determines that the unmanned light vehicle 1 is not in the full state.

In Step SB34, in a case where it is determined to interrupt the circulation of the unmanned light vehicle 1 (Step SB34: Yes), the assignment unit 128 assigns another unmanned light vehicle 1 to the circulation. The assignment unit 128 causes the other unmanned light vehicle 1 to travel toward the interruption point (Step SB35).

Furthermore, in a case where it is determined to interrupt the circulation of the unmanned light vehicle 1, the assignment unit 128 transmits to the unmanned light vehicle 1 an operation command for interrupting the circulation of the unmanned light vehicle 1.

In a case where it is determined in Step SB34 that the circulation of the unmanned light vehicle 1 is not interrupted (Step SB34: No), the assignment unit 128 transmits to the unmanned light vehicle 1 an operation command for continuing the circulation of the unmanned light vehicle 1.

The travel control unit 155 of the unmanned light vehicle 1 determines whether or not to interrupt the circulation of the unmanned light vehicle 1 based on the operation command transmitted from the assignment unit 128 (Step SA34).

In a case where the operation command for interrupting the circulation is transmitted from the assignment unit 128, the travel control unit 155 determines to interrupt the circulation of the unmanned light vehicle 1. In a case where the operation command for continuing the circulation is transmitted from the assignment unit 128, the travel control unit 155 determines to continue the circulation of the unmanned light vehicle 1.

In Step SA34, in a case where it is determined to interrupt the circulation of the unmanned light vehicle 1 (Step SA34: Yes), the travel control unit 155 interrupts the circulation of the unmanned light vehicle 1. The unmanned light vehicle 1 goes straight from the interruption point to the return point without stopping at the circulation positions 41.

In a case where it is determined in Step SA34 that the circulation of the unmanned light vehicle 1 is not interrupted (Step SA34: No), the travel control unit 155 continues the circulation of the unmanned light vehicle 1. The unmanned light vehicle 1 travels to the return point while stopping at the circulation positions 41.

After starting the circulation (Step SA33), the unmanned light vehicle 1 and the management device 12 constantly or periodically repeat the processing from Step SB33 to Step SB35 and the processing from Step SA34 to Step SA35 until the unmanned light vehicle 1 interrupts the circulation or until the unmanned light vehicle 1 arrives at the return point.

### Advantageous Effects

As described above, in the present embodiment, the unmanned light vehicle 1 travels so as to circulate the work site 10. The travel path 32 is generated so as to pass through the plurality of circulation positions 41. Since at least a part of the plurality of circulation positions 41 is the getting-on/off position of the operator, the unmanned light vehicle 1 can smoothly pick up and drop off the operator to the getting-on/off position.

### OTHER EMBODIMENTS

In the above-described embodiments, the work machine 8 is an excavator. The work machine 8 is not limited to an excavator. The work machine 8 may be a bulldozer, a motor grader, or a wheel loader.

According to the present disclosure, traffic of operators at a work site is smoothly performed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A management system for an autonomous travel vehicle, comprising:
a work machine position acquisition unit that acquires a position of a work machine operated by an operator and having a travel device; and
a target position determination unit that determines a target position of the autonomous travel vehicle based on the position of the work machine.

2. The management system for an autonomous travel vehicle according to claim 1, wherein
the target position is a getting-on/off position of the operator.

3. The management system for an autonomous travel vehicle according to claim 1, further comprising
a position transmission unit that transmits a position of the work machine.

4. The management system for an autonomous travel vehicle according to claim 3, wherein
the position transmission unit is disposed in the work machine.

5. The management system for an autonomous travel vehicle according to claim 4, further comprising
a work machine designation unit that is disposed in the autonomous travel vehicle and designates the work machine.

6. The management system for an autonomous travel vehicle according to claim 3, wherein
the position transmission unit includes a communication terminal that can be carried by the operator.

7. The management system for an autonomous travel vehicle according to claim 1, wherein
the position of the work machine is a position of an excavator including a revolving body and working equipment supported by the revolving body.

8. The management system for an autonomous travel vehicle according to claim 1, further comprising
a pick-up request unit that transmits a pick-up request of the operator.

9. The management system for an autonomous travel vehicle according to claim 8, wherein
the pick-up request unit is disposed in the work machine.

10. The management system for an autonomous travel vehicle according to claim 1, further comprising
a transfer request unit that transmits a transfer request to send the operator to a target position.

11. The management system for an autonomous travel vehicle according to claim 1, further comprising
a circulation path generation unit that generates, based on a plurality of circulation positions, a travel path when the autonomous travel vehicle is circulated at a work site,
wherein at least one of the plurality of circulation positions is a getting-on/off position of the operator.

12. The management system for an autonomous travel vehicle according to claim 11, wherein
the circulation positions include an arbitrary fixed position.

13. The management system for an autonomous travel vehicle according to claim 12, wherein
the fixed position is a position of a gas station of the work machine.

14. The management system for an autonomous travel vehicle according to claim 11, further comprising
a schedule management unit that manages a departure time or a return time of the autonomous travel vehicle.

15. The management system for an autonomous travel vehicle according to claim 11, further comprising
a boarding state recognition unit that recognizes a boarding state of a person in the autonomous travel vehicle.

16. The management system for an autonomous travel vehicle according to claim 15, wherein
the boarding state recognition unit determines whether or not the autonomous travel vehicle is in a full state, and
the management system further comprises an assignment unit that interrupts circulation of the autonomous travel vehicle and returns the autonomous travel vehicle to a return point when it is determined that the autonomous travel vehicle is in the full state during the circulation of the autonomous travel vehicle.

17. The management system for an autonomous travel vehicle according to claim 16, wherein
when the circulation of the autonomous travel vehicle determined to be in the full state is interrupted, the assignment unit causes another autonomous travel vehicle to travel to an interruption point.

18. A management method for an autonomous travel vehicle, comprising:
acquiring a position of a work machine operated by an operator and having a travel device; and
determining a target position of the autonomous travel vehicle based on the position of the work machine.

19. The management method for an autonomous travel vehicle according to claim 18, wherein
the target position is a getting-on/off position of the operator.

20. The management method for an autonomous travel vehicle according to claim 18, further comprising
generating, based on a plurality of circulation positions, a travel path when the autonomous travel vehicle is circulated at a work site,
wherein at least one of the plurality of circulation positions is a getting-on/off position of the operator.
